(19) United States
(12) Patent Application Publication
(10) Pub. No.: US 2018/0068334 A1
(43) Pub. Date: Mar. 8, 2018

(54) METHOD AND SYSTEM FOR MANAGING A GAMIFIED TRUSTEE BASED SOCIAL AUTHENTICATION TO RECOVER AN ACCOUNT OF A USER

(71) Applicant: The King Abdulaziz City for Science and Technology, Riyadh (SA)

(72) Inventors: Noura Nassir Alomar, Riyadh (SA); Mansour Abdulrahman Alsaleh, Riyadh (SA)

(73) Assignee: The King Abdulaziz City for Science and Technology, Riyadh (SA)

(21) Appl. No.: 15/259,047

(22) Filed: Sep. 8, 2016

(51) Int. Cl. G06Q 30/02; H04L 29/06; G06Q 50/00

(52) U.S. Cl. CPC G06Q 30/0209; G06Q 50/01; H04L 63/102

(57) ABSTRACT

The invention provides a method and system for managing a gamified trustee based social authentication to recover an account of a user. The method for managing the gamified trustee based social authentication to recover the account of the user includes the step of registering a plurality of trustees associated with the user. Then, the method receives a vouching request from the user for recovering the account of the user. In response to receiving the vouching request, the method forwards the vouching request to the plurality of trustees for verifying the user for recovering the account. Further, the method rewards at least one trustee of the plurality of trustees in response to the at least one trustee responding to the vouching request.

### FIELD OF THE INVENTION

The invention generally relates to a field of trustee based social authentication to recover an account of a user. More specifically, the invention relates to a method and system for enabling a user to send a vouching request to one or more trustees for recovering an account of the user and rewarding the one or more trustees using game elements based on responses provided by the trustees to the vouching request.

### BACKGROUND OF THE INVENTION

Social networks or Web services commonly use passwords to authenticate a user for providing access approval for an account. The user may loss access to the account by forgetting a password for the account or by several login attempts with incorrect passwords or by attacks made by the hackers to change the passwords. In order to prevent the user from a loss of account, the social networks use contacts or user connections associated with the account of the user as an authentication mechanism for a recovery of the account.

Existing authentication mechanisms rely on trustees selected by the user from the contacts or the user connections to recover the account of the user. When the user initiates a request to recover the account, the authentication mechanism sends security codes/vouch codes to the trustees and requests the users to collect the security codes from the trustees. By collecting all the vouch codes, the user gains the access to the account.

In general, an availability of the trustees is essential in the existing authenticating mechanisms for the user to collect the vouch codes. An unavailability of at least one trustee prevents the user from gaining access to the account. A delay associated with collecting the vouch codes from the at least one trustee requires the user to restart a recovery process to recollect vouch codes. Restart of the recovery process increases the effort that needs to be taken by the user to recover the account and also negatively impacts on user experience. Thus, the user needs to select the trustees carefully in the existing authentication mechanisms and also the user needs to make sure that the trustees are available and willing to help whenever the user wants to regain the access to the account.

However, the user may not guarantee the availability of trustees at a time of recovering the account. Also the user may select the fake accounts as trustees or the user may not know whether the trustees are willing to help at a time of recovering the account.

Further, the existing mechanisms do not encourage or motivate the trustees to vouch for an identity of the user with least possible delay by providing any incentives.

Therefore, there is a need for a method and system for managing a gamified trustee-based social authentication for recovering an account of a user in an efficient manner.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates an environment comprising a trustee based social authentication system to recover an account of a user.

FIG. 2 illustrates a system for managing a gamified trustee based social authentication to recover an account of a user in accordance with an embodiment of the invention.

FIG. 3 illustrates a flowchart for managing a gamified trustee based social authentication to recover an account of a user in accordance with an embodiment of the invention.

FIG. 4 illustrates a flowchart for selecting a trustee from a plurality of trustees to recover an account of a user in accordance with an embodiment of the invention.

FIG. 5 illustrates a computer program product for managing a gamified trustee based social authentication to recover an account of a user in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and system components related to provide a gamified trustee based social authentication to recover an account of a user and rewarding trustees using game elements based on responses provided by the trustees to a vouching request.

Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article or composition that comprises a list of elements does not include only those elements but may include other elements not expressly listed or inherent to such process, method, article or composition. An element proceeded by “comprises . . . a” does not, without more constraints, preclude the existence of additional identical elements in the process, method, article or composition that comprises the element.

Various embodiments of the invention provide a method and system for managing a gamified trustee based social authentication to recover an account of a user. The method for managing the gamified trustee based social authentication to recover the account of the user includes the step of registering a plurality of trustees associated with the user. Then, the method receives a vouching request from the user for recovering the account of the user. In response to receiving the vouching request, the method forwards the vouching request to the plurality of trustees for verifying the user for recovering the account. Thereafter, in response to the one or more trustees responding to the vouching request, the method rewards the one or more trustees.

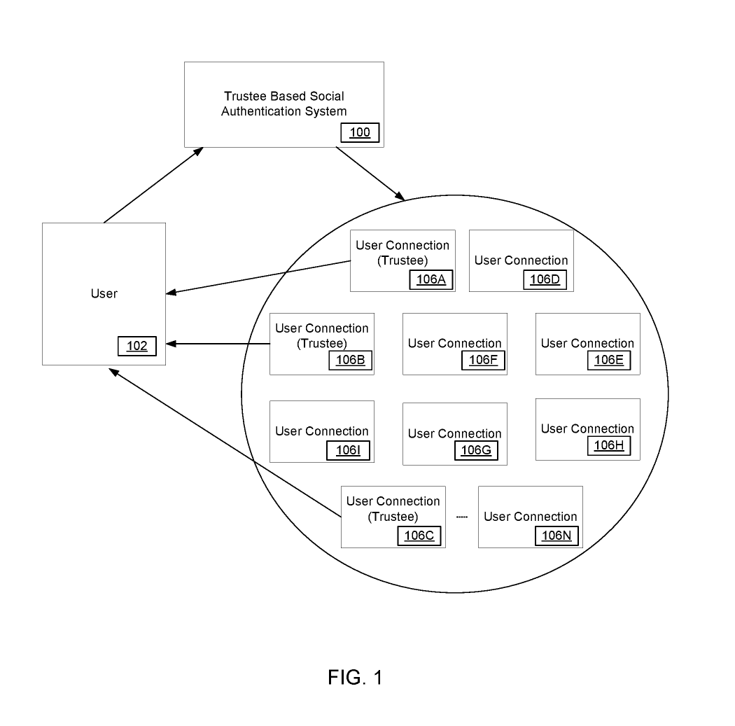

FIG. 1 illustrates an exemplary environment comprising a trustee based social authentication system 100 to recover an account of a user 102.

As illustrated in FIG. 1, trustee based social authentication system 100 is configured to recover the account of user 102 based on vouch codes received by trustees 106A-106C.

Trustee based social authentication system 100 allows user 102 to create an account with user credentials and password. Once the account is created, trustee based social authentication system 100 enables user 102 to register trustees for the account. Trustees 106A-106C are selected by user 102 from user connections 106A-106N. User connections 106A-106N refer to members or friends or any person or other users formed relationship or associativity with user 102 in a social network.

Trustee based social authentication system 100 receives a vouching request from user 102, when user 102 losses access to the account or forgets the password for the account. Based on the vouching request, trustee based social authentication system 100 verifies identities of trustees 106A-106C.

In order to verify trustees 106A-106C, trustee based social authentication system 100 communicates with trustees to obtain information that verifies the authenticity of trustees 106A-106C. Once trustees 106A-106C are verified, trustee based social authentication system 100 sends the vouch codes to trustees 106A-106C.

By sending the vouch codes to trustees 106A-106C, trustee based social authentication system 100 requests user 102 to collect the vouch codes from trustees 106A-106C. Also, trustee based social authentication system 100 sets a recovery threshold for a recovery of the account. The recovery threshold refers to a number of vouch codes needs to be collected by user 102.

If user 102 collects the vouch codes greater than or equal to recovery threshold from trustees 106A-106C, trustee based social authentication system 100 allows user 102 to recover the account in the social network.

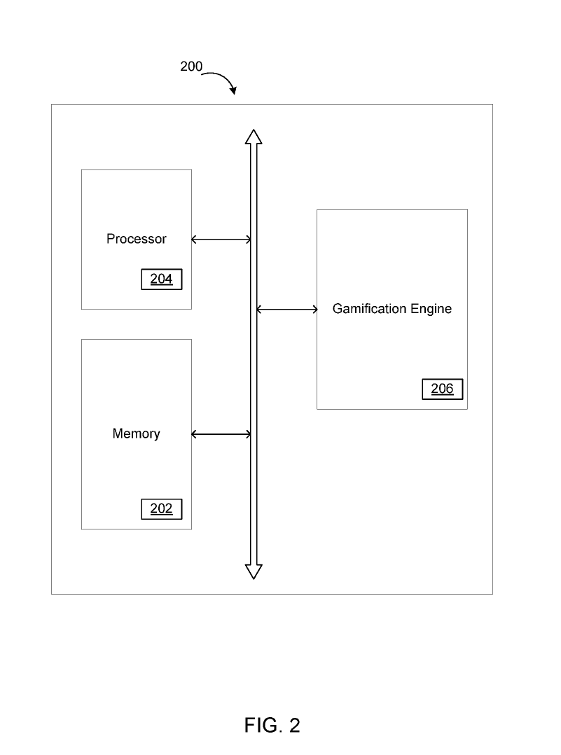

In order to motivate trustees to send vouch codes with a minimum delay, the invention provides a method and system for managing a gamified trustee-based social authentication to recover an account of a user. Accordingly, a system for managing a gamified trustee based social authentication to recover an account of a user is further described in detail in conjunction with FIG. 2.

FIG. 2 illustrates a system 200 for managing a gamified trustee based social authentication to recover an account of a user in accordance with an embodiment of the invention.

As illustrated in FIG. 2, system 200 includes a memory 202 and a processor 204 communicatively coupled to memory 102. In accordance with the method and system disclosed, processor 204 is configured to register a plurality of trustees associated with the user. The plurality or trustees are selected by the user from user connections associated with the account of the user in the social network. The user connections include, but need not limited to, friends, members, contacts and other users associated with the account of the user in the social network.

In an embodiment, the user registers the plurality of trustees based on factors such as, but need not limited to, how long the user has known the plurality of trustees, relationship with the plurality of trustees and frequency of interactions with the plurality of trustees.

In an instance, when the user losses access to the user account, the user initiates a recovery process by sending a request to processor 204 for a vouching request. The user sends the vouching request using user device such as, but need not limited to, a mobile device, a personal digital assistant, a computer, a laptop, a smart phone and a tablet.

In response to receiving the vouching request, processor 204 forwards the vouching request to the plurality of trustees for verifying the user for recovering the account of the user. Processor 204 obtains information about the plurality of trustees registered by the user and forwards the vouching request to the plurality of trustees. Once one or more trustees of the plurality of trustees responds to the vouching request, processor 204 sends vouch codes required to vouch for an identity of the user after verifying the trustee.

The vouch codes includes, but need not limited to, a web link and a plurality of characters. Sending the vouch codes includes, but need not limited to, sending the vouch codes through text messages, emails, voice mails and similar type of communication.

Once the vouching requests are forwarded to the plurality of trustees by processor 204, one or more trustees of the plurality of the trustees may respond to the vouching request for enabling the user to recover the user account. The system includes a gamification engine 206 communicatively coupled to both memory 202 and processor 204 that rewards the one or more trustees of the plurality of trustees using one or more game elements in response to the one or more trustees responding to the vouching request.

The one or more game elements utilized to reward the one or more trustees includes, but need not limited to, number of points corresponding to a vouching-related achievement of a trustee, a confidence score, an incentive, a badge, a leaderboard rank and an update to a progress bar.

Gamification engine 206 rewards a trustee using the one or more game elements based on a set of parameters associated with the trustee. The set of parameters include, but need not limited to, an amount of time taken by the trustee to respond to the vouching request, a degree of importance of the account associated with the user in a social network and a reputation level of the trustee.

In an embodiment, gamification engine 206 determines the degree of importance of the account of the user based on a set of factors to award trustees using a number of game elements. The set of factors include, but need not limited to, a number of connections associated with the account of the user in the social network, a degree of separation between the account of the user and a corresponding account of the trustee and a set of degree centrality metrics.

In an exemplary embodiment, gamification engine 206 offers a maximum number of rewards using one or more game elements to a trustee when the trustee responds to a vouching request with a less time or if the trustee responds first to the vouching request. In another exemplary embodiment, gamification engine 206 offers a maximum number of rewards using one or more game elements to a trustee when the trustee is the first one to respond to a vouching request corresponding to an account of the user that has a high importance. Also, gamification engine 206 offers the maximum number of rewards using the one or more game elements to a trustee with a high reputation score.

In an embodiment, gamification engine 206 motivates a trustee to vouch for an identity of the user with a least possible delay by awarding a number of rewards using one or more game elements. Thus, gamification engine 206 reduces a probability of ignoring a vouching request by the trustee or probability of waiting by a user for vouch codes.

Also, gamification engine 206 ranks plurality of trustees based on the number of rewards accumulated by the trustee over a predefined time period. Ranking the plurality of trustees helps the plurality of trustees to improve a reputation level in a social network. The number of rewards (provided by utilizing one or more game elements) accumulated by the trustee reflects the reputation level of the trustee in the social network with respect to the trustee's readiness and willingness to help the user to recover blocked account in the social network.

In another embodiment, processor 104 selects a trustee from a plurality of trustees for verifying a user for recovering an account based on a number of points accumulated by the trustee. The number of points accumulated by the trustee represents previous vouching related achievements of the trustee in a social network.

Processor 104 selects the trustee based on the number of points in order to avoid the difficulty faced by the user in selecting the trustee. Selecting the trustee based on the number of points awarded by gamification engine 106 aids the user to know the trustee willing to help at a time of recovering the account. Also, selecting the trustee based on the number of points ensures a selection of the trustee likely to be available at the time of recovering the account.

Once the trustee is selected, processor 104 enables the trustee to send vouch codes to the user. Thus, the user recovers the account by collecting the vouch codes from the trustee.

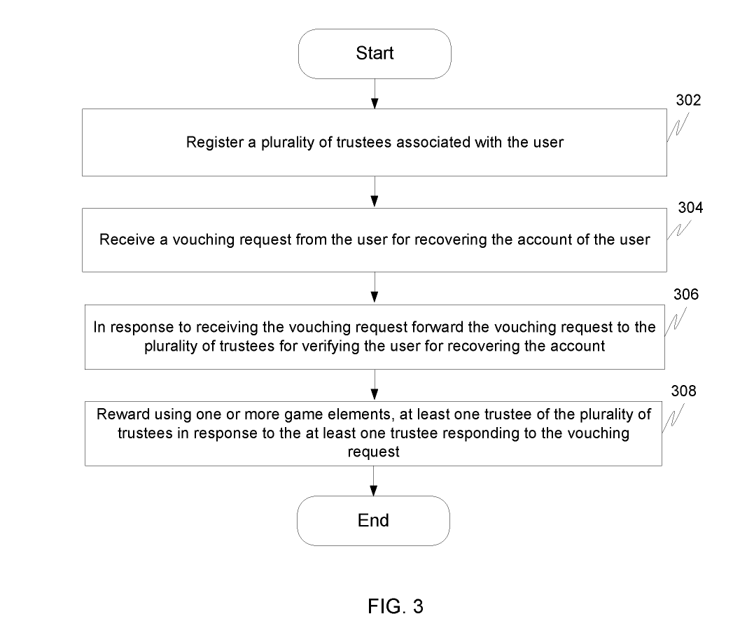

FIG. 3 illustrates a flowchart for managing a gamified trustee based social authentication to recover an account of a user in accordance with an embodiment of the invention.

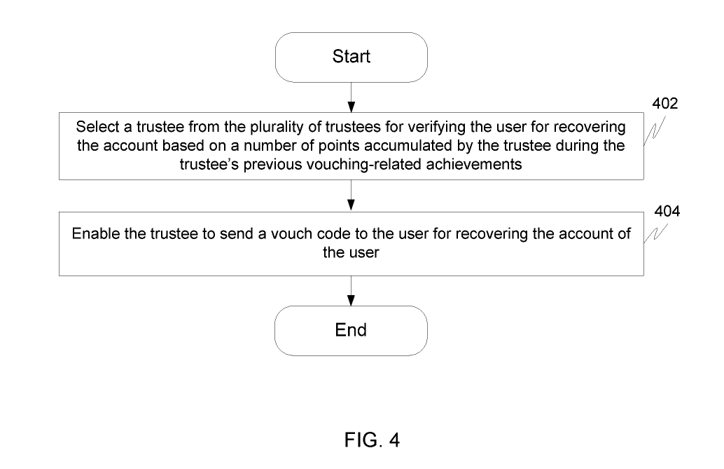

At step 302, a plurality of trustees associated with the user are registered by processor 204. The plurality or trustees are selected by the user from user connections associated with the account of the user in a social network. The user connections include, but need not limited to, friends, members, contacts and other users associated with the account of the user in a social network. In another embodiment, processor 204 may select one or more trustees for the user, this is further explained in conjunction with the FIG. 4.

Then, at step 304, a vouching request from the user is received by processor 204 for recovering the account of the user.

In response to receiving the vouching request, at step 306, the vouching request is forwarded by processor 204 to the plurality of trustees for verifying the user for recovering the account.

In response to one or more trustees responding to the vouching request, at step 308, one or more trustees of the plurality of trustee are rewarded by gamification engine 206 using one or more game elements. The one or more game elements utilized to reward the one or more trustees includes, but need not limited to, number of points corresponding to a vouching-related achievement of a trustee, a confidence score, an incentive, a badge, a leaderboard rank and an update to a progress bar.

FIG. 4 illustrates a flowchart for selecting a trustee from a plurality of trustees to recover an account of a user in accordance with an embodiment of the invention.

At step 402, a trustee from the plurality of trustees are selected by processor 204 for verifying the user for recovering the account based on number of points accumulated by the trustee during the trustee's previous vouching related achievements.

Thereafter, at step 404, the trustee is enabled by the processor 204 to send a vouch code to the user for recovering the account of the user.

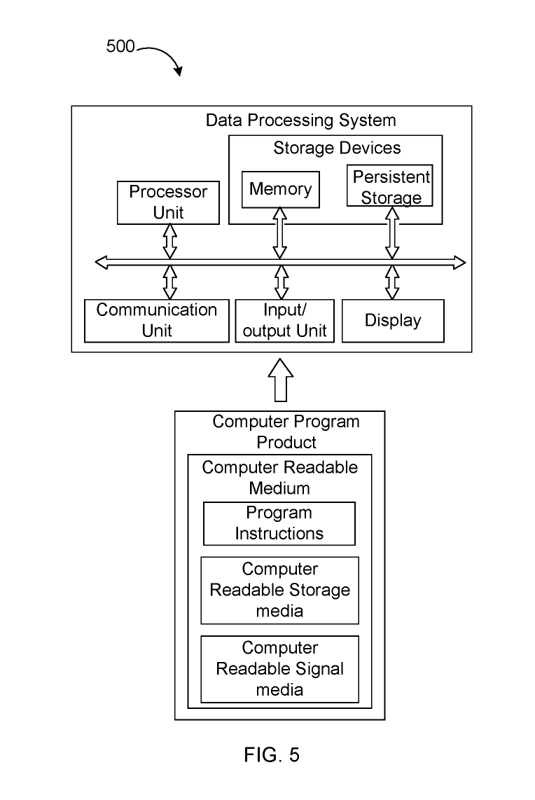

FIG. 5 illustrates a computer program product 500 for managing a gamified trustee based social authentication to recover an account of a user in accordance with an embodiment of the invention.

An embodiment of the present invention may relate to a computer program product with a non-transitory computer readable medium having program instructions thereon for performing various computer-implemented operations of the method and/or system disclosed herein. The computer readable storage media and program instructions may be those specially designed and constructed for the purposes of the method and/or system disclosed herein, or, they may be of the kind well known and available to those having skill in the computer software arts. Examples of computer-readable storage media include, but are not limited to, magnetic media, optical media, magneto-optical media and hardware devices that are specially configured to store and execute program instructions. Examples of program instructions include machine code, such as produced by a compiler, and files containing higher-level code that are executed by a computer using an interpreter. For example, an embodiment of the present invention may be implemented using JAVA®, C++, or other object-oriented programming language and development tools. Aspects of the present invention may also be implemented using Hypertext Transport Protocol (HTTP), Procedural Scripting Languages and the like.

The present invention provides a gamified trustee based social authentication system to motivate trustees to respond to vouching requests for fast recovery of an account of a user. Rewards are provided to the trustees using game elements based on responses provided to the vouching requests. A number of rewards awarded to the trustees using the indicates a willingness of the trustees to vouch for identities of the user. Utilizing the game elements to reward the trustees increases a sense of competition between the trustees and encourages the trustees to respond to the vouching requests quickly. Also, availability of the trustees needed at a time of recovery of an account of the user may be guaranteed.

The determination of the number of rewards provided to the trustees using the game elements depends on an amount of time taken by the trustees to respond to the vouching requests and a degree of importance of the account associated with the user in a social network.

A trustee with a highest number of rewards (provided using the game elements) is selected from the plurality of the trustees selected by the user in order to send the vouch code. Selection of the trustee based on the highest number of rewards solves the problem associated with the user in selecting the trustee likely to be available when needed.

Different trustees are selected for each vouching request based on the number of rewards accumulated by the trustees. The number of rewards accumulated by the trustees varies depending on achievements of the users or responses provided to the vouching requests. Thus, malicious user finds difficulty in identifying the trustees responding to the vouching requests for recovery of the account of the user.

In the gamified trustee based social authentication system, fake accounts selected as trustees are not able to accumulate the number of rewards to vouch for an identity of the user in the future. The gamified trustee-based social authentication system helps to avoid the fake accounts that attempt to clone the identities of trustees. Also, the gamified trustee-based social authentication system avoids the fake accounts from developing the reputation level in the social network. The reputation level allows the trustees to be selected to respond to the vouching requests.

The gamified trustee based social authentication system may be deployed in any online social network along with enterprise contexts that allows user to vouch for identities of other users present in a same social network. In enterprise contexts, workers are awarded for vouching for the identities of other workers present in a same enterprise.

Those skilled in the art will realize that the above recognized advantages and other advantages described herein are merely exemplary and are not meant to be a complete rendering of all of the advantages of the various embodiments of the invention.

The system, as described in the invention or any of its components may be embodied in the form of a computing device. The computing device can be, for example, but not limited to, a general-purpose computer, a programmed microprocessor, a micro-controller, a peripheral integrated circuit element, and other devices or arrangements of devices, which are capable of implementing the steps that constitute the method of the invention. The computing device includes a processor, a memory, a nonvolatile data storage, a display, and a user interface.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for managing a gamified trustee based social authentication to recover an account of a user, the method comprising:
registering, by one or more processors, a plurality of trustees associated with the user;
receiving, by one or more processors, a vouching request from the user for recovering the account of the user;
in response to receiving the vouching request, forwarding, by one or more processors, the vouching request to the plurality of trustees for verifying the user for recovering the account; and
rewarding, by one or more processors, using one or more game elements, at least one trustee of the plurality of trustees in response to the at least one trustee responding to the vouching request.

2. The method according to claim 1, wherein rewarding, by one or more processors, using one or more game elements comprises providing at least one of a number of points corresponding to a vouching-related achievement of a trustee, a confidence score, an incentive, a badge, a leaderboard rank and an update to a progress bar based on a set of parameters associated with a trustee.

3. The method according to claim 2, wherein the set of parameters comprises at least one of an amount of time taken by a trustee to respond to a vouching request, a degree of importance of a user's account in a social network and a reputation level of the trustee.

4. The method according to claim 3, wherein a degree of importance of a user's account is determined based on a set of factors comprising at least one of a number of connections associated with the user's account in the social network, a degree of separation between a user's account and a corresponding at least one trustee account and a set of degree centrality metrics.

5. The method according to claim 3 further comprises, awarding a maximum number of points to a trustee based on at least one of, the trustee responding first to a vouching request of the user, the trustee responding to a vouching request corresponding to a user's account that has a high degree of importance and the trustee having a high reputation score.

6. The method according to claim 2 further comprises ranking, by one or more processors, the plurality of trustees based on the number of points accumulated by each trustee over a predefined time period.

7. A method according to claim 2 further comprises:
selecting, by one or more processors, a trustee from the plurality of trustees for verifying the user for recovering the account based on a number of points accumulated by the trustee during the trustee's previous vouching-related achievements; and
enabling, by one or more processors, the trustee to send a vouch code to the user for recovering the account of the user.

8. A system for managing a gamified trustee based social authentication to recover an account of a user, the system comprising:
a memory;
a processor communicatively coupled to the memory, wherein the processor is configured to:
register a plurality of trustees associated with the user;
receive a vouching request from the user for recovering the account of the user;
in response to receiving the vouching request, forward the vouching request to the plurality of trustees for verifying the user for recovering the account; and
a gamification engine communicatively coupled to the memory and the processor, the gamification engine configured to reward, using one or more game elements, at least one trustee of the plurality of trustees in response to the at least one trustee responding to the vouching request.

9. The system according to claim 8, wherein the gamification engine is further configured to reward, using one or more game elements, the at least one trustee by providing at least one of a number of points corresponding to a vouching-related achievement of a trustee, a confidence score, an incentive, a badge, a leaderboard rank and an update to a progress bar based on a set of parameters associated with a trustee.

10. The system according to claim 9, wherein the set of parameters comprises at least one of an amount of time taken by a trustee to respond to a vouching request, a degree of importance of a user's account in a social network and a reputation level of the trustee.

11. The system according to claim 10, wherein the gamification engine is further configured to award a maximum number of points to a trustee based on at least one of, the trustee responding first to a vouching request of the user, the trustee responding to a vouching request corresponding to a user's account that has a high degree of importance and the trustee having a high reputation score.

12. The system according to claim 9, wherein the gamification engine is further configured to rank the plurality of trustees based on the number of points accumulated by each trustee over a predefined time period.

13. The system according to claim 9, wherein the processor is further configured to:
select a trustee from the plurality of trustees for verifying the user for recovering the account based on a number of points accumulated by the trustee during the trustee's previous vouching-related achievements; and
enable the trustee to send a vouch code to the user for recovering the account of the user.

14. A computer program product for managing a gamified trustee based social authentication to recover an account of a user, the computer program product comprising a non-transitory computer readable medium having program instructions stored therein, the program instructions readable/executable by a processor to cause the processor to:
register a plurality of trustees associated with the user;
receive a vouching request from the user for recovering the account of the user;
in response to receiving the vouching request, forward the vouching request to the plurality of trustees for verifying the user for recovering the account; and
reward, using one or more game elements, at least one trustee of the plurality of trustees in response to the at least one trustee responding to the vouching request.

15. The computer program product according to claim 14, wherein the program instructions further cause the processor to reward, using one or more game elements, the at least one trustee by providing at least one of a number of points corresponding to a vouching-related achievement of a trustee, a confidence score, an incentive, a badge, a leaderboard rank and an update to a progress bar based on a set of parameters associated with a trustee.

16. The computer program product according to claim 15, wherein the set of parameters comprises at least one of an amount of time taken by a trustee to respond to a vouching request, a degree of importance of a user's account in a social network and a reputation level of the trustee.

17. The computer program product according to claim 16, wherein the program instructions further cause the processor to award a maximum number of points to a trustee based on at least one of, the trustee responding first to a vouching request of the user, the trustee responding to a vouching request corresponding to a user's account that has a high degree of importance and the trustee having a high reputation score.

18. The computer program product according to claim 15, wherein the program instructions further cause the processor to rank the plurality of trustees based on the number of points accumulated by each trustee over a predefined time period.

19. The computer program product according to claim 15, wherein the program instructions further cause the processor to:
select a trustee from the plurality of trustees for verifying the user for recovering the account based on a number of points accumulated by the trustee during the trustee's previous vouching-related achievements; and
enable the trustee to send a vouch code to the user for recovering the account of the user.
